(19) United States
(12) Patent Application Publication
(10) Pub. No.: US 2018/0179810 A1
(43) Pub. Date: Jun. 28, 2018

(54) Seal and Protect Strip

(71) Applicant: Wayne Yoson, Flemington, NJ (US)

(72) Inventor: Wayne Yoson, Flemington, NJ (US)

(21) Appl. No.: 15/393,161

(22) Filed: Dec. 28, 2016

(51) Int. Cl. E06B 7/23

(52) U.S. Cl. CPC E06B 7/2305

(57) ABSTRACT

The present invention provides an adhesive cushioning with removable backing that can be utilized to elevate work, secure on a wall for protection, seal under a doorway, or for other uses of choice. The cushioning comprises an elongated foam member, with adhesive pull-away backing with a variety of scoring marks that allow for the sizing of the elongated member. Further, said adhesive pull-away backing may be positioned over multiple surfaces of the exterior of the elongated member.

### BACKGROUND

This invention relates to improvements in adhesive cushioning. During the construction process, doors and windows are removed allowing noise, dust and fumes to travel throughout the rest of the home or facility under construction. However, construction sites utilize power tools that generate significant noise and dust and debris which can be disruptive and distracting to workers throughout the entire construction site. Some contractors may secure a piece of plywood over the opening, but this can damage the work around the trim. Additionally, finished floors can be damaged from any sort of contact from people, tool chests, power tools, and the like. There exists a need for a device that can removable secure a piece of plywood or other barrier over a door opening, window opening or other passage through which noise, dust, fumes or debris may traverse as well as protecting other surfaces from damage that may otherwise occur.

### BRIEF DESCRIPTION OF FIGURES

FIG. 1A shows a perspective view of one embodiment of the present invention prior to one use.

FIG. 1B shows a perspective view of one embodiment of the present invention after one use.

FIG. 2 shows a perspective view of one embodiment of the present invention.

FIG. 3 shows a perspective view of one embodiment of the present invention.

FIG. 4A shows a perspective view of one embodiment of the present invention prior to one use.

FIG. 4B shows a perspective view of one embodiment of the present invention after one use.

FIG. 5A shows a perspective view of one embodiment of the present invention prior to one use.

FIG. 5B shows a perspective view of one embodiment of the present invention after one use.

FIG. 6 shows an alternate embodiment with a lip to accommodate a sheet of plywood or other material.

### DESCRIPTION OF INVENTION

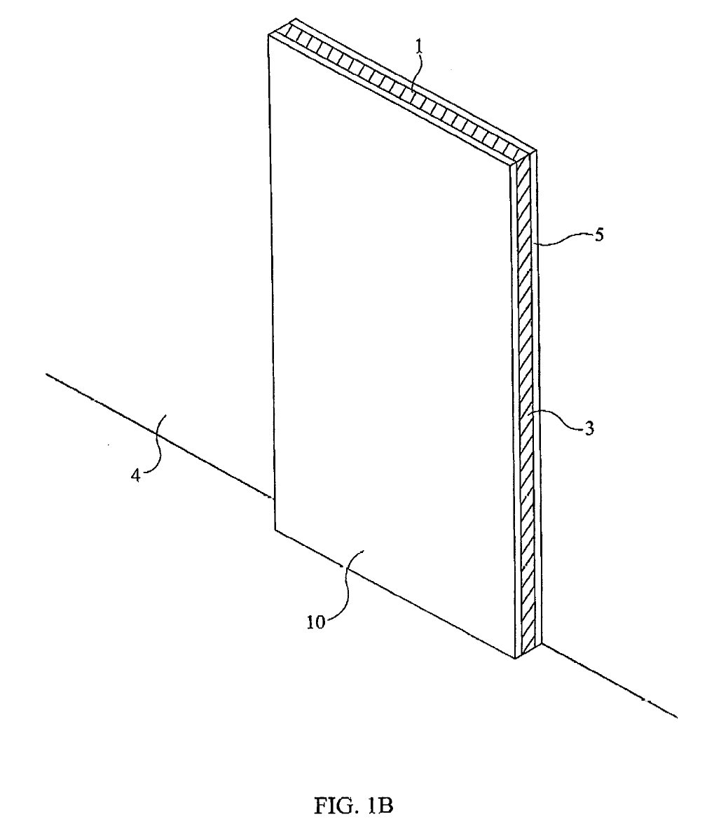

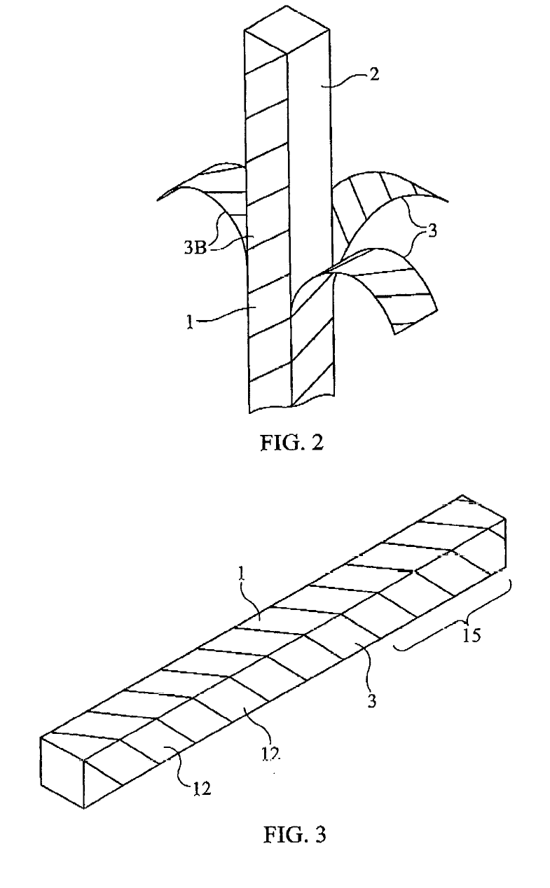

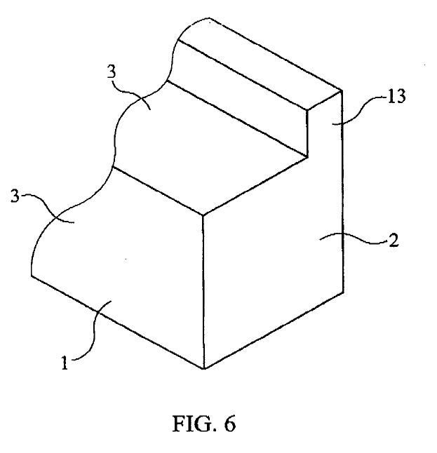

Referring now to FIGS. 2-3, there are shown views of one embodiment of the present invention 1. The present invention provides an adhesive cushioning 2 with removable backing 3 that can be utilized to elevate work, secure on a wall 4 for protection, seal over a doorway 5, or for other uses of choice. The cushioning 2 comprises an elongated foam member with adhesive pull-away backing 3. In the shown embodiment, the member 1 has a rectangular cross-section, however in alternative embodiments the member 1 may have a cross section of any suitable configuration. In FIG. 6 one embodiment, the foam member 1 includes a raised lip 13 on the end to help secure plywood or other material and to prevent slippage. Further, the device can include scoring lines 12 for braking the member 1 into small pieces. The foam member 1 may be constructed from polystyrene or other suitable material.

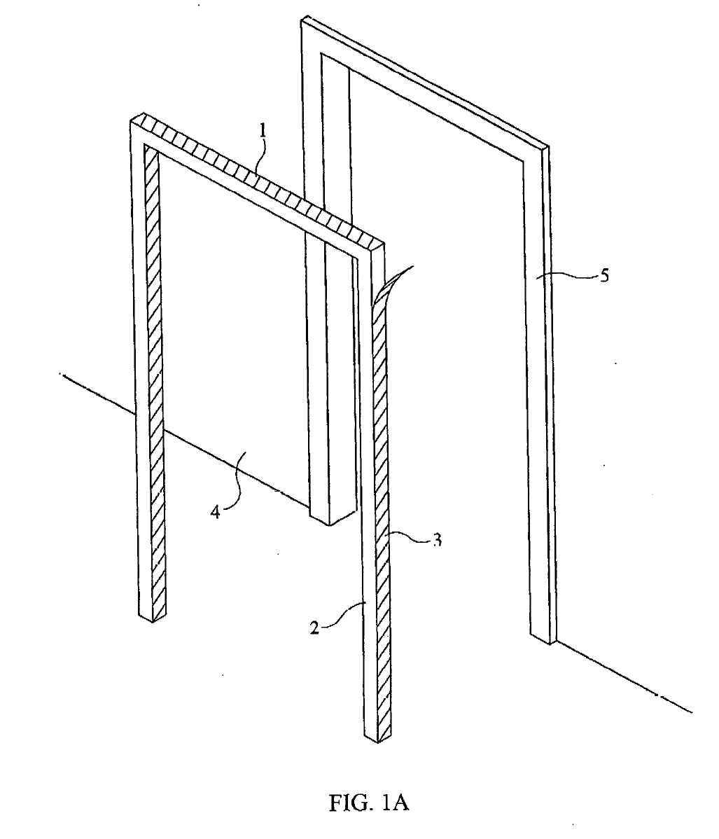

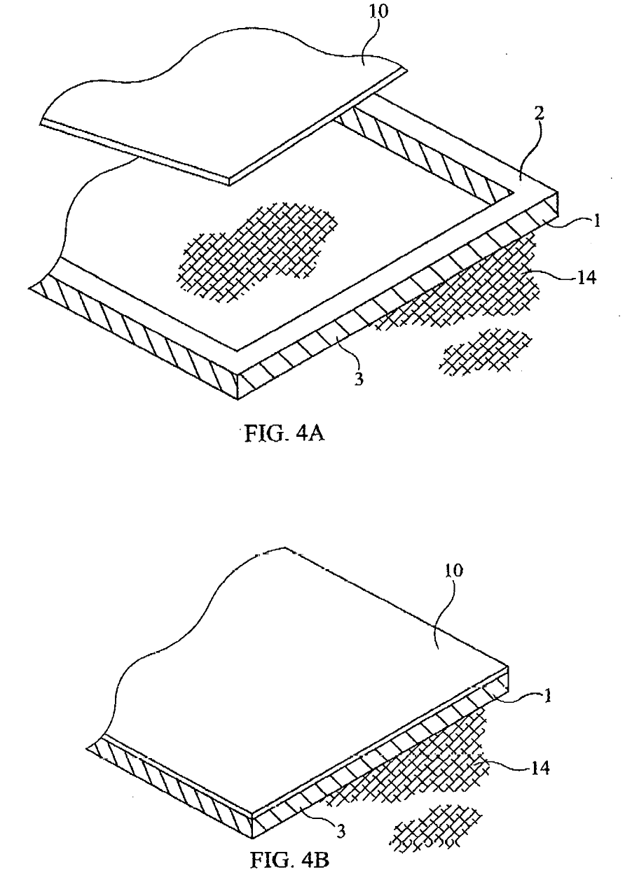

Referring now to FIGS. 1A, 1B, 4A and 4B, there are shown views of several embodiments of the present invention prior to and after use. In the shown embodiment (FIG. 1B), the elongated foam member 1 is used to secure a planar wood member 10 to a door frame 5 such that it covers the door entranceway. The wood member 10 is secured to the door frame 5 by adhering a side of the wood member 10 to a first side 3 of the foam member 1, and securing the opposing side 3B of the foam member 1 to the door frame 5. In the shown embodiment (FIGS. 4A 4B), the elongated foam member 1 is used to cover a portion of the floor 14 by adhering a planar wood member 10 to the foam member 1, which is in turn affixed to the floor 14.

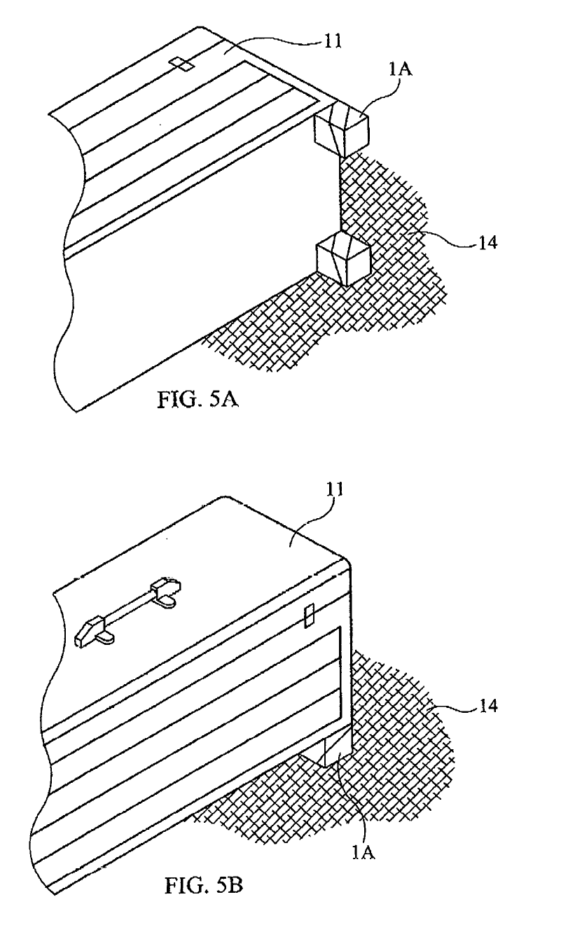

Referring now to FIGS. 5A-5B, there are shown views of one embodiment of the present invention prior to and after one use. In the shown embodiment 1, the scoring lines 12 as shown in FIG. 3 of the foam member 1 has been utilized to size the pieces for this use. The smaller foam members 1A are being used on the underside of a container 11 to secure the container to the floor 14. In addition, the removable backing 3 of the elongated member 1 can have black and orange or other colored caution stripes 15 as shown in FIG. 3 to indicate that the backing 3 has not been removed.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. For example embodiments with triangular, rectangular, trapezoidal or other shapes are specifically contemplated. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A foam cushioning and sealing device comprising a foam member with a plurality of adhesive coated surfaces with removable backing.

2. A foam cushioning and sealing device as described in claim 1, wherein said device has a square cross section.

3. A foam cushioning and sealing device as described in claim 1, wherein said device has a rectangular cross section.

4. A foam cushioning and sealing device as described in claim 1, wherein said device has a triangular cross section.

5. A foam cushioning and sealing device as described in claim 1, wherein said device has a trapezoidal cross section.

6. A foam cushioning and sealing device as described in claim 1, wherein said removable backing have colored caution stripes.

7. A foam cushioning and sealing device as described in claim 1, wherein said device has a raised lip on one or more of said coated surfaces.
